(19) United States
(12) Patent Application Publication
(10) Pub. No.: US 2012/0047327 A1
(43) Pub. Date: Feb. 23, 2012

(54) Disk array device and control method for the same

(75) Inventor: Akihiro Ueda, Kawasaki (JP)

(73) Assignee: FUJITSU LIMITED, Kawasaki (JP)

(21) Appl. No.: 13/067,104

(22) Filed: May 9, 2011

(30) Foreign Application Priority Data
Aug. 20, 2010 (JP) 2010-185507

(51) Int. Cl. G06F 12/00

(52) U.S. Cl. 711/114; 711/E12.001

(57) ABSTRACT

A disk array device includes a disk group that stores therein data, and stores therein an upper limit of multiplicity capable of multiple data transfer using a line, for each line connected with a transfer destination device being a transfer destination of the data stored in the disk group. When data transfer is to be executed, the disk array device acquires the upper limit stored in association with the line connected with the transfer destination device of the data transfer. The disk array device also acquires current multiplicity of the data currently transferred through the line. When it is determined that the multiplicity does not exceed the upper limit even if the data transfer is executed, the disk array device executes the data transfer.

### CROSS-REFERENCE TO RELATED APPLICATION

This application is based upon and claims the benefit of priority of the prior Japanese Patent Application No. 2010-185507, filed on Aug. 20, 2010, the entire contents of which are incorporated herein by reference.

### FIELD

The embodiments discussed herein are directed to a disk array device and a control method for the disk array device.

### BACKGROUND

In recent years, enterprises manage various pieces of information such as business information and personnel information as electronic data (hereinafter, “data”). However, because loss of the data leads to business suspension or to fallen credibility, the enterprises take some measures against system failure caused by a disaster, man-made malfunction, and cracking, or the like.

Remote copy has been known as the measures against the system failure. The remote copy is implemented in such a manner that data is transferred to and stored in a remote site geometrically far from a site where a storage device for storing therein the data is installed. For example, a transfer source device and a transfer destination device are connected to each other using a remote line such as a wide-area Ethernet (Trademark) and a dedicated line, and the data is periodically transferred from the transfer source to the transfer destination to be backed-up. If a system failure occurs in the transfer source device, the data in the transfer source device is recovered by the data stored in the transfer destination device.

The remote copy is implemented by connecting between the transfer source device and the transfer destination device over a remote line different from LAN (Local Area Network) used for general job. As for the remote copy, therefore, the backup of the data is less influential to the general job. By storing the data in the remote site in this manner, the data can be recovered even in the failure without affecting the general job, thus improving reliability of the system.

As a storage device that efficiently implements the remote copy, there is known a storage device that sets multiplicity based on line information such as execution speed of line and a line-response delay time of a remote line and executes data transfer based on the set multiplicity. For example, the number of executions of copy capable of being performed in parallel is set based on the line information, and data copy is executed using the set number of executions. As one example, when the multiplicity is set to 5, the storage device executes five data copies in parallel.

However, there is a problem that a storage device that sets the multiplicity based on the line information for a conventional remote line is incapable of executing data transfer with the multiplicity suitable for the line.

In the conventional technology, for example, when one transfer-source storage device and a plurality of transfer-destination storage devices are connected via one remote line, the multiplicity is set for each between the storage devices. Therefore, when the data transfer is concurrently executed in each between the storage devices, the remote line may exceed an allowable amount of data transfer, and thus the data transfer cannot be executed with the multiplicity suitable for the line.

As one example, there is a case where a transfer-source storage device A and a transfer-destination storage device B, and the transfer-source storage device A and a transfer-destination storage device C are commonly connected to the remote line whose allowable multiplicity is 8 at 500 Mbps. In this case, “500 Mbps, multiplicity: 8” is determined as multiplicity between the transfer-source storage device A and the transfer-destination storage device B, and “500 Mbps, multiplicity: 8” is also set as multiplicity between the transfer-source storage device A and the transfer-destination storage device C.

Consequently, when data transfer from the transfer-source storage device A to the transfer-destination storage device B and data transfer from the transfer-source storage device A to the transfer-destination storage device C are concurrently executed, data transfer with multiplicity of 16 is executed on the remote line. However, this exceeds the allowable range of the remote line. Therefore, in the conventional technology, setting of “250 Mbps, multiplicity: 4” or the like is changed in each of the storage devices, and each multiplicity is changed so as not to exceed the allowable range of the remote line even if these data transfers are concurrently executed, and then the data transfers are executed.

That is, in the conventional technology, there may be a case where the data transfer cannot be executed with the determined multiplicity and the multiplicity has to be therefore set again before execution of the data transfer, which is inefficient.

Patent Document 1: Japanese Laid-open Patent Publication No. 2004-145855

Patent Document 2: Japanese Laid-open Patent Publication No. 2006-318491

### SUMMARY

According to an aspect of an embodiment of the invention, a disk array device include a storage unit that stores therein data; a transfer-multiplicity storage unit that stores therein an upper limit of multiplicity capable of data transfer in parallel using a line for each line which is connected with a transfer destination device being a transfer destination of data stored in the storage unit; a multiplicity determining unit that determines, when data transfer is to be executed, whether execution of the data transfer does not cause multiplicity to exceed the upper limit, based on the upper limit stored in the transfer-multiplicity storage unit in association with a line connected with a transfer destination device of the data transfer and also based on current multiplicity of the data currently transferred using the line; and an execution control unit that executes the data transfer when it is determined by the multiplicity determining unit that the multiplicity does not exceed the upper limit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram of an entire configuration of a remote copy system including a disk array device according to a first embodiment;

FIG. 2 is a block diagram of a configuration of a disk array device according to a second embodiment;

FIG. 3 is a diagram representing an example of remote line information stored in a remote line table;

FIG. 4 is a diagram representing an example of disk information stored in a disk information table;

FIG. 5 is a diagram representing an example of session information stored in a session information table;

FIG. 6 is a flowchart representing a flow of a REC-path generation process according to the second embodiment;

FIG. 7 is a flowchart representing a flow of a data copy execution process according to the second embodiment;

FIG. 8 is a flowchart representing a flow of a process after execution of data copy according to the second embodiment;

FIG. 9 is a flowchart representing a flow of a REC-path generation process according to a third embodiment;

FIG. 10 is a diagram representing an example of disk information stored in a disk information table according to the third embodiment;

FIG. 11 is a flowchart representing a flow of a data copy execution process according to the third embodiment; and

FIG. 12 is a flowchart representing a flow of a path failover process upon data transfer.

### DESCRIPTION OF EMBODIMENTS

Preferred embodiments of the present invention will be explained with reference to accompanying drawings. However, the present invention is not limited by the embodiments.

### [a] First Embodiment

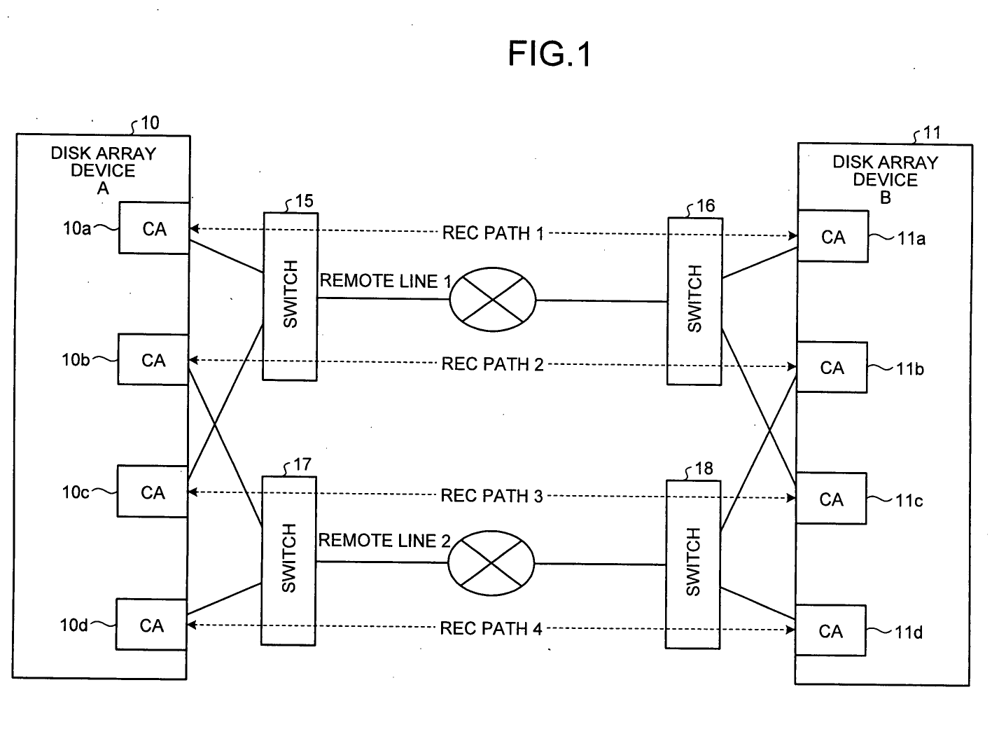

FIG. 1 is a diagram of an entire configuration of a remote copy system including a disk array device according to a first embodiment. As represented in FIG. 1, this system includes a disk array device A 10, a disk array device B 11, a switch 15, a switch 16, a switch 17, and a switch 18. The disk array device A 10 and the disk array device B 11 are mutually communicably connected to each other over a remote line 1 and a remote line 2 being a network such as a wide-area Ethernet (Trademark) and a LAN (Local Area Network).

The remote copy system represented in FIG. 1 makes the line redundant by installing the disk array device A 10 and the disk array device B 11 in geographically remote sites and connecting the two devices with the remote line 1 and the remote line 2 whose carriers or the like are different from each other. This system is used to achieve so-called remote copy in which data is copied from the disk array device A 10 into the disk array device B 11, and is achieved by REC (Remote Equivalent Copy) using, for example, a synchronization-separation system.

The synchronization-separation system is a system that makes a copy while synchronizing the business data and has a suspend/resume function for copying only a difference between the business data and the previous data in second copying and thereafter. However, the embodiment is not limited thereto. For example, there can be used a background copy system for copying real data in the background at an arbitrary timing after only the pointer of the data is first copied, or a copy-on-write system for copying only data before updating when the data is updated. In other words, the disk array device disclosed in the present embodiment is capable of executing remote copy using any one of the systems.

In the disk array device A 10 of the system, a CA (channel adapter) 10a and the switch 15 are connected to each other using a fiber channel (FC) or the like, and a CA 10c and the switch 15 are connected using the FC or the like. Moreover, in the disk array device A 10, a CA 10b and the switch 17 are connected using the FC or the like, and a CA 10d and the switch 17 are connected using the FC or the like. The disk array device A 10 is a device that forms RAID (Redundant Arrays of Inexpensive Disks) with a plurality of disks and stores therein data, and functions as a copy source device for copying data into the disk array device B 11 in this embodiment.

The disk array device A 10 uses physical wiring provided between this device and the disk array device B 11, to internally determine REC path 1 through REC path 4 being logical paths. The REC path 1 is a physical path between the CA 10a of the disk array device A 10 and a CA 11a of the disk array device B 11. The REC path 2 is a physical path between the CA 10b of the disk array device A 10 and a CA 11b of the disk array device B 11. The REC path 3 is a physical path between the CA 10c of the disk array device A 10 and a CA 11c of the disk array device B 11. The REC path 4 is a physical path between the CA 10d of the disk array device A 10 and a CA 11d of the disk array device B 11.

The disk array device B 11 connects between the CA 11a and the switch 16 using the FC or the like and connects between the CA 11c and the switch 16 using the FC or the like. In addition, the disk array device B 11 connects between the CA 11b and the switch 18 using the FC or the like and connects between the CA 11d and the switch 18 using the FC or the like. The disk array device B 11 is also a device that forms RAID with a plurality of disks and stores therein data, and functions as a copy destination device for receiving the data from the disk array device A 10 and storing therein the received data.

The switch 15 is a network device such as an FC switch connecting to the disk array device A 10 through the FC and connecting to the switch 16 through the remote line 1. Likewise, the switch 17 is a network device connecting to the disk array device A 10 through the FC or the like and connecting to the switch 18 through the remote line 2. The switch 16 is also a network device connecting to the disk array device B 11 through the FC or the like and connecting to the switch 15 through the remote line 1. Likewise, the switch 18 is a network device connecting to the disk array device B 11 through the FC or the like and connecting to the switch 17 through the remote line 2.

The switch 15 through the switch 18 are not limited to the FC switch, and thus various devices can be used depending on a protocol or a type of a remote line connected to the disk array device. For example, when the switch and the disk array device are connected to each other using iSCSI (Internet Small Computer System Interface) or Ethernet (Trademark) is used for the remote line, a network device such as a router and a L3 switch can be used.

FIG. 1 has explained an example in which the copy source device and the copy destination device are connected to each other one-to-one, however, the present embodiment is not limited thereto. Therefore, even if these devices are connected to each other one-to-N, N-to-one, or N-to-N (N: natural number), the method disclosed in the present embodiment can be applied to these cases. The number of the switches and the number of CAs of the disk array device represented in FIG. 1 are not also limited thereto.

In such a state, the disk array device A 10 stores an upper limit of the multiplicity capable of performing multiple data transfer using the remote line for each remote line connected with the disk array device B 11 being a copy destination of data to be stored in a disk. When the copy of the data is to be executed, the disk array device A 10 acquires an upper limit stored in association with the remote line connected with the disk array device B 11. The disk array device A 10 also acquires current multiplicity of the data currently transferred through the remote line. Subsequently, the disk array device A 10 determines whether execution of the data copy does not cause the multiplicity, operating through the remote line, to exceed the upper limit, based on the upper limit and the current multiplicity. When it is determined that the multiplicity does not exceed the upper limit, the disk array device A 10 executes the data copy.

For example, the disk array device A 10 determines whether the multiplicity of the remote line 1 is within the upper limit at the time of executing a copy session to the disk array device B 11 using the remote line 1, and executes the copy session only when it is within the upper limit. That is, the disk array device A 10 manages an execution status of a copy session for each remote line, executes the data copy when the execution status is within the allowable range, and stops the data copy when the execution status exceeds the allowable range. In this manner, the disk array device A 10 can execute copying by making maximum use of the multiplicity allowable for the remote line. This allows execution of data transfer with the multiplicity suitable for the remote line.

### [b] Second Embodiment

Next, one example of the disk array device disclosed in a second embodiment will be explained. A configuration of the disk array device, a flow of process, and effect due to the second embodiment will be sequentially explained in the second embodiment. The disk array device explained herein is a copy source device that executes copying and corresponds to the disk array device A 10 in the example of FIG. 1. The copying system and the remote line or the like are the same as these of the first embodiment, and thus explanation thereof is omitted herein.

Configuration of Disk Array Device

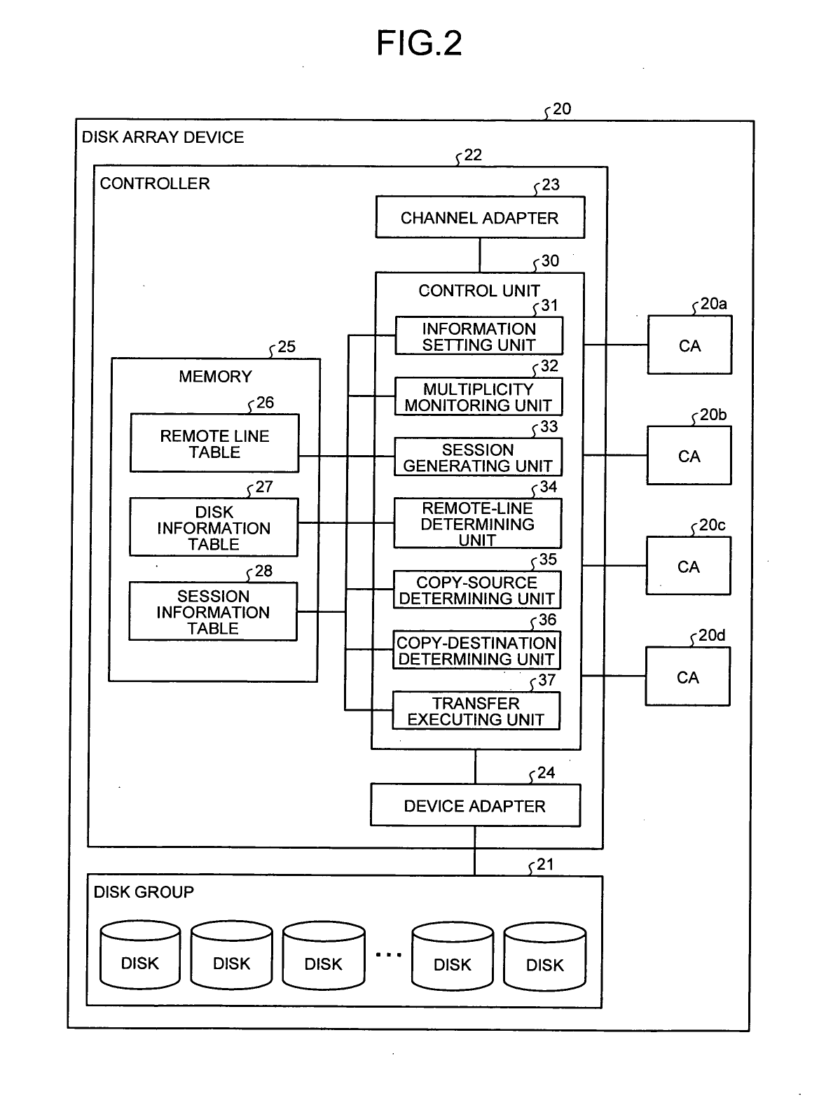

First, the configuration of the disk array device disclosed in the present embodiment will be explained below. FIG. 2 is a block diagram of the configuration of a disk array device according to the second embodiment. As represented in FIG. 2, a disk array device 20 includes CA 20a to CA 20d, a disk group 21, and a controller 22.

The CA 20a to CA 20d are interfaces connecting to copy-destination disk array devices through remote lines and controlling data transmission/reception to/from the copy-destination disk array devices, respectively. For example, each of the CA 20a to CA 20d is connected to the FC switch through the FC or the like and is connected to the remote line via the FC switch. Each of the CA 20a to CA 20d transmits data to a copy destination via the FC switch. The disk array device 20 stores REC paths being logical paths, in a memory 25 or the like, which are internally set by a manager or the like using physical wiring provided between each of the CA 20a to CA 20d of its own device and a CA of a copy destination device.

The disk group 21 is a storage unit that includes a plurality of disks and forms RAID such as RAID-0 and RAID-5 to store therein various types of data. The disks provided in the disk group 21 are those used in HDD (Hard Disk Drive) and SSD (Solid State Disk), and thus various disks can be used.

The controller 22 is a processor that performs data control such as data write and data read to and from the disk group 21 and copy control for copying data for the disk group 21 into other disk array devices. The controller 22 includes a channel adapter 23, a device adapter 24, the memory 25, and a control unit 30.

The channel adapter 23 is an interface for controlling communication with a host server that performs data write and data read to and from the disk array device 20, and is connected to the host server using the FC or the iSCSI. For example, the channel adapter 23 outputs a data write request received from the host server to the control unit 30, receives the result of the data write from the control unit 30, and transmits the result to the host server.

The channel adapter 23 also outputs a data read request received from the host server to the control unit 30, receives the result of the data read from the control unit 30, and transmits the result to the host server. The channel adapter 23 is connected to a terminal of the manager or the like who manages the disk array device 20, receives information such as setting of REC path and setting of RAID, and outputs the information to the control unit 30.

The device adapter 24 is an initiator or the like that is connected to the disk group 21 using the FC or the like and controls communications with the disk group 21. For example, the device adapter 24 writes data to a write position of the disk group 21 received from the control unit 30, and outputs the result to the control unit 30. In addition, the device adapter 24 reads data from a read position of the disk group 21 received from the control unit 30, and outputs the read data to the control unit 30.

The memory 25 is a storage unit that stores therein various pieces of information required when the control unit 30 executes data copy. The memory 25 includes a remote line table 26, a disk information table 27, and a session information table 28.

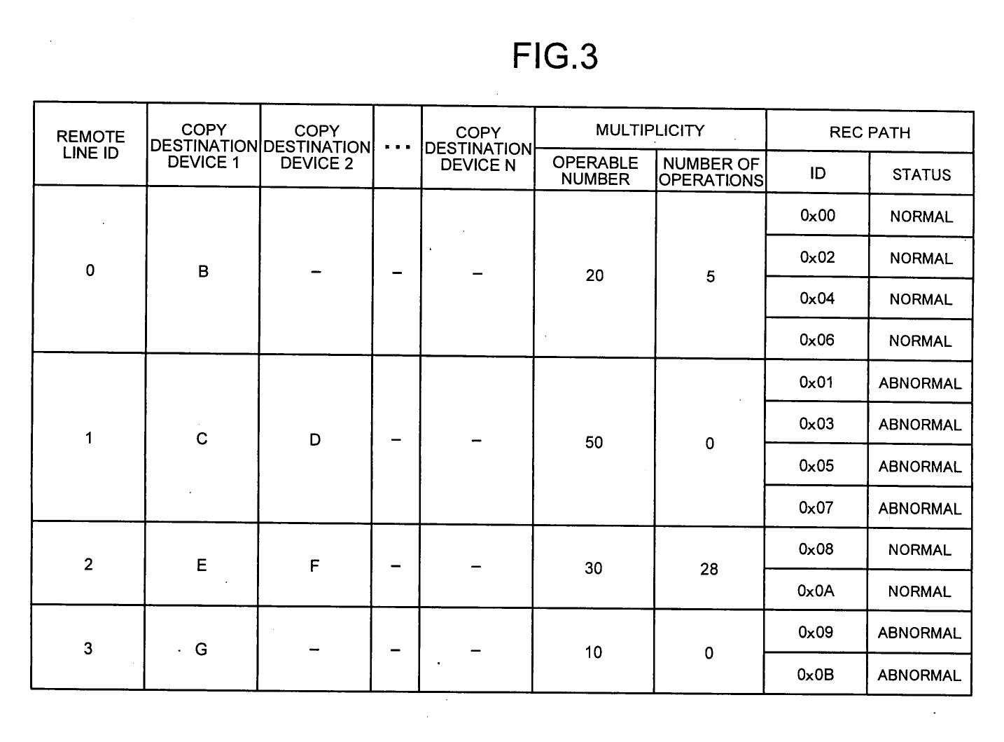

The remote line table 26 stores therein an upper limit of the multiplicity capable of multiple data transfer through the remote line and current multiplicity of data currently copied through the remote line, for each remote line connected with a transfer destination device being a transfer destination of data stored in the disk group 21. FIG. 3 is a diagram representing an example of remote line information stored in the remote line table. For example, as represented in FIG. 3, the remote line table 26 stores therein “Remote line ID, Copy destination device 1, Copy destination device 2, . . . , Copy destination device N (N: arbitrary natural number), Multiplicity (operable number, number of operations), and REC path (ID, status)”.

The “Remote line ID” stored herein is an identifier for uniquely identifying a remote line which is specified by an operator or is automatically allocated by a disk array device. The “Copy destination device 1, Copy destination device 2, . . . , and Copy destination device N” are identifiers such as a host name indicating a copy-destination disk array device connected through the remote line. The “Multiplicity (operable number)” is an upper limit of the multiplicity capable of executing a copy session through the remote line, or is the number of copies that can be concurrently operated over the remote line. The “multiplicity (operable number)” is uniquely determined for each remote line, from execution speed of line and a line-response delay time of the remote line. Therefore, when disk array devices are connected through a plurality of remote lines, each of multiplicities can be a different value for each remote line.

The “multiplicity (number of operations)” is the multiplicity of a copy session currently operating using the remote line. That is, the “multiplicity (number of operations)” is the number of concurrently executing copy communications at the moment, which indicates a load at the current point of time of the remote line. The “REC path (ID)” is an identifier for uniquely identifying a REC path indicating a copy path internally determined in the disk array device 20. The “REC path (status)” is information indicating a status of the REC path, and “normal” is stored in the remote line table 26 when the REC path is normally operating and is communicable, while “abnormal” is stored therein when it is incapable of communication.

In the case of FIG. 3, connected to a remote line having “Remote line ID=0” is a disk array device B as a copy destination device, and four REC paths of “ID=0x00, 0x02, 0x04, and 0x06” are set in this remote line, all of which are normally operating. As the upper limit of operable multiplicity, “20” is set in this remote line, and five (multiplicity of five) data communications are currently executed.

Connected to a remote line having “Remote line ID=1” are disk array devices C and D as copy destination devices, and four REC paths of “ID=0x01, 0x03, 0x05, and 0x07” are set in this remote line, all of which are in abnormal status being incapable of communication. As the upper limit of operable multiplicity, “50” is set in this remote line, and data communication is not currently executed.

Connected to a remote line having “Remote line ID=2” are disk array devices E and F as copy destination devices, and two REC paths of “ID=0x08 and 0x0A” are set in this remote line, both of which are normally operating. As the upper limit of operable multiplicity, “30” is set in this remote line, and 28 data communications are currently executed.

Connected to a remote line having “Remote line ID=3” is a disk array device G as a copy destination device, and two REC paths of “ID=0x09 and 0x0B” are set in this remote line, both of which are in abnormal status being incapable of communication. As the upper limit of operable multiplicity, “10” is set in this remote line, and data communication is not currently executed. It should be noted that the numbers and the characters represented in FIG. 3 have no particular meaning and are just exemplified. Therefore, the numbers and the characters are not limited thereto.

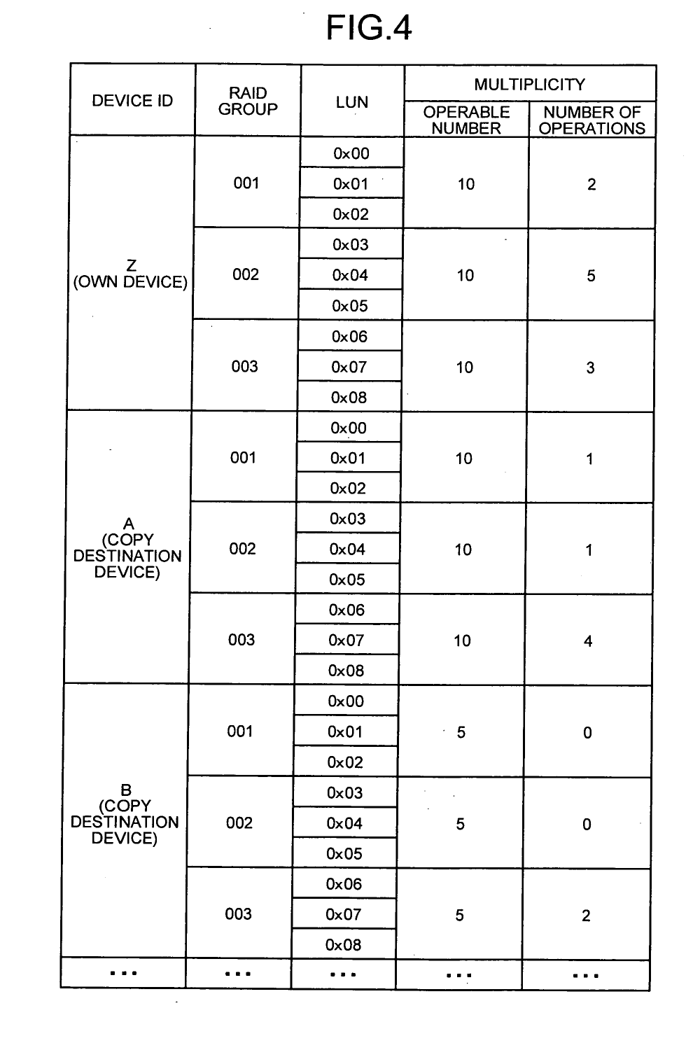

Referring back to FIG. 2, the disk information table 27 stores therein the upper limit of the multiplicity capable of performing multiple access to the RAID group and current multiplicity currently accessing the RAID group, for each RAID group formed in the disk group 21. The disk information table 27 also stores therein the upper limit of the multiplicity capable of accessing the RAID group and the current multiplicity currently accessing the RAID group, for each RAID group formed in the copy destination device. FIG. 4 is a diagram representing an example of disk information stored in the disk information table. For example, the disk information table 27 stores therein “Device ID, RAID group, LUN (Logical Unit Number), and Multiplicity (operable number, number of operations)”.

The “Device ID” stored herein is an identifier such as a device name for uniquely identifying its own device or a copy-destination disk array device. The “RAID group” is an identifier for identifying a RAID group formed in the disk group 21 or in a copy destination device, and also an identifier for identifying a group forming one logical disk in combination of physical disks. The “LUN” is an identifier for identifying a logical volume in the disk group 21 or in the copy destination device, and is a unit recognized by the disk array device, as a logical volume created by one from the RAID group or created by dividing the RAID group into a plurality of portions.

The “Multiplicity (operable number)” is the upper limit of multiplicity capable of accessing the RAID group. That is, this “Multiplicity (operable number)” is not limited to the number of copy operations, but is the concurrently executable number of various disk accesses such as data write and data read, and indicates a maximum load allowable for the RAID group. The “Multiplicity (operable number)” is uniquely determined by the type and the capacity of a disk.

The “Multiplicity (number of operations)” is the multiplicity of current access to the RAID group. That is, the “Multiplicity (number of operations)” is the number of disk accesses concurrently executed at the moment, including the number of copy operations, reference to data and data write, or the like, which indicates a load at the current time of the RAID group. The “Multiplicity (number of operations)” is incremented when a copy session is executed or when another disk access is executed, while it is decremented when a copy session is ended or when another disk access is ended.

In the case of FIG. 4, the own device having “Device ID=Z” is formed with RAID groups of “001”, “002”, and “003”. The RAID group of “001” is formed with three LUNs having “ID=0x00, 0x01, 0x02”, “10” is set therein as the upper limit of operable multiplicity, and two accesses are currently executed. Likewise, the RAID group of “002” is formed with three LUNs having “ID=0x03, 0x04, 0x05”, “10” is set therein as the upper limit of operable multiplicity, and five accesses are currently executed. In addition, the RAID group of “003” is formed with three LUNs having “ID=0x06, 0x07, 0x08”, “10” is set therein as the upper limit of operable multiplicity, and three accesses are currently executed.

Formed in a copy destination device having “Device ID=A” are RAID groups of “001”, “002”, and “003”. The RAID group of “001” is formed with three LUNs having “ID=0x00, 0x01, 0x02”, “10” is set therein as the upper limit of operable multiplicity, and one access is currently executed. Likewise, the RAID group of “002” is formed with three LUNs having “ID=0x03, 0x04, 0x05”, “10” is set therein as the upper limit of operable multiplicity, and one access is currently executed. In addition, the RAID group of “003” is formed with three LUNs having “ID=0x06, 0x07, 0x08”, “10” is set therein as the upper limit of operable multiplicity, and four accesses are currently executed.

Formed in a copy destination device having “Device ID=B” are RAID groups of “001”, “002”, and “003”. The RAID group of “001” is formed with three LUNs having “ID=0x00, 0x01, 0x02”, “5” is set therein as the upper limit of operable multiplicity, and no access is currently executed. Likewise, the RAID group of “002” is formed with three LUNs having “ID=0x03, 0x04, 0x05”, “5” is set therein as the upper limit of operable multiplicity, and no access is currently executed. In addition, the RAID group of “003” is formed with three LUNs having “ID=0x06, 0x07, 0x08”, “5” is set therein as the upper limit of operable multiplicity, and two accesses are currently executed. It should be noted that the numbers and the characters represented in FIG. 4 have no particular meaning and are just exemplified. Therefore, the numbers and the characters are not limited thereto. The number of current accesses in the copy destination device indicates copy operations executed by the copy source device, and therefore the copy source device can obtain the number of current accesses in the copy destination device. As explained above, because the copy operations can be obtained, any access not related to the copy operations is negligible.

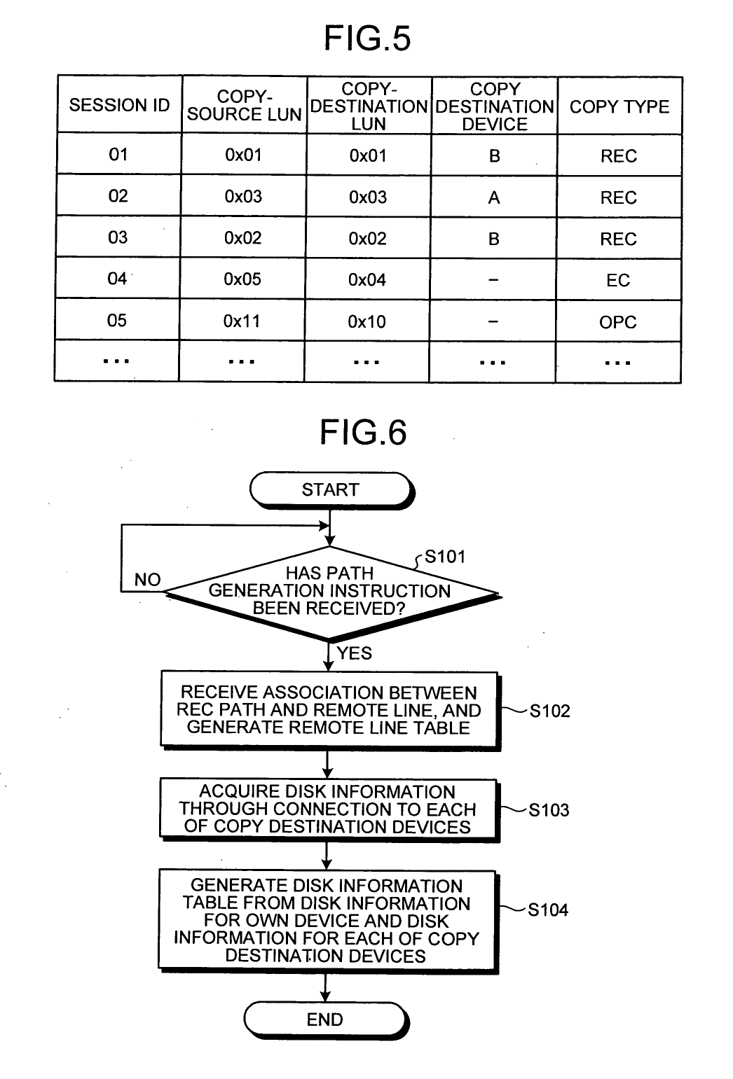

Referring back to FIG. 2, the session information table 28 is data generated by the manager or the like, and stores therein a copy session indicating information for the target data to be copied. FIG. 5 is a diagram representing an example of session information stored in the session information table. For example, as represented in FIG. 5, the session information table 28 stores therein “Session ID, Copy-source LUN, Copy-destination LUN, Copy destination device, and Copy type”. In addition to the information represented in FIG. 5, the session information table 28 may store therein “In execution”, “Unexecuted”, and “Abnormally ended” as information indicating statuses of the copy session. The information stored in the session information table 28 may be deleted after executed and ended, and may be newly generated when the information is abnormally ended.

The “Session ID” stored herein is an identifier for identifying a copy session indicating information related to target data to be copied. The “Copy-source LUN” is an identifier of logical volume where a target data to be copied is stored. The “Copy-destination LUN” is an identifier of logical volume of copy destination. The “Copy destination device” is an identifier such as a host name for identifying a copy-destination disk array device, and when the identifier indicates data copy within the own device, “−” is stored therein. The “Copy type” indicates a method of an advanced copy function for executing fast copy only by the disk array device without using a CPU (central processing unit) of a server, and stores therein “REC” in the case of, for example, remote copy.

In the case of volume copy in the device, the “Copy type” stores therein “EC (Equivalent Copy)”, “OPC (One Point Copy)”, “QuickOPC”, “SnapOPC”, and “SnapOPC+”, or the like. The “EC” is a function for creating backup using the synchronization-separation system, the “OPC” is a function for creating backup using a background system, and the “QuickOPC” is a function for creating backup using the background system similar to the “OPC”. However, the “QuickOPC” is the function for copying data only for a difference when a second copy instruction and thereafter are received. The “SnapOPC” is a system for copying copy source data before its update, and the “SnapOPC+” is a function for creating a snapshot using a copy-on-write system.

In the case of FIG. 5, the copy session with “Session ID=01” indicates that the data for LUN “0x01” of the disk group 21 in the disk array device 20 being the own device is remotely copied into LUN “0x01” of “Disk array device B”. The copy session with “Session ID=02” indicates that the data for LUN “0x03” of the disk group 21 is remotely copied into LUN “0x03” of “Disk array device A”. In addition, the copy session with “Session ID=03” indicates that the data for LUN “0x02” of the disk group 21 is remotely copied into LUN “0x02” of “Disk array device B”.

The copy session with “Session ID=04” indicates that the data for LUN “0x05” of the disk group 21 in the own device is copied into LUN “0x04” of the same disk group 21 using the EC system. In addition, the copy session with “Session ID=05” indicates that the data for LUN “0x11” of the disk group 21 in the own device is copied into LUN “0x10” of the same disk group 21 using the OPC system. It should be noted that the numbers and the characters represented in FIG. 5 have no particular meaning and are just exemplified. Therefore, the numbers and the characters are not limited thereto.

Referring back to FIG. 2, the control unit 30 is a processor that executes various controls related to data copy and RAID, and includes an information setting unit 31, a multiplicity monitoring unit 32, a session generating unit 33, a remote-line determining unit 34, a copy-source determining unit 35, a copy-destination determining unit 36, and a transfer executing unit 37. The control unit 30 also includes a function as a RAID controller for controlling RAID configuration and LUNs of the disk group 21.

The information setting unit 31 receives an operation by the manager or the like, and stores various types of information in the remote line table 26. The information setting unit 31 also receives an operation by the manager or the like, and generates a REC path being a logical path internally determined in the disk array device 20. For example, the information setting unit 31 receives “Remote line ID, Copy destination devices 1 to N, Multiplicity (operable number), REC path (ID, status)” from a manager terminal or the like connected thereto via the channel adapter 23. The information setting unit 31 stores the received information in the remote line table 26.

The information setting unit 31 can also automatically acquire “Remote line ID and Copy destination devices 1 to N” of the remote line table 26 using known methods such as PING. The information setting unit 31 receives execution speed of line and a line-response delay time of a remote line from the manager terminal, and can also calculate the “Multiplicity (operable number)” of the remote line table 26 using the known method.

The information setting unit 31 stores various pieces of information in the disk information table 27. For example, the information setting unit 31 acquires “Device ID, RAID group, LUN, and Multiplicity (operable number)” of the own device set by the RAID controller provided in the control unit 30 from the RAID controller. The information setting unit 31 then stores the acquired information as disk information for the own device in the disk information table 27.

The information setting unit 31 connects to each of the copy destination devices and acquires “Device ID, RAID group, LUN, and Multiplicity (operable number)” set by each of the copy destination devices. The information setting unit 31 then stores the acquired information as disk information for the copy destination device in the disk information table 27.

The information setting unit 31 may receive “Device ID, RAID group, and LUN” of the disk information table 27 from the manager terminal or the like connected thereto via the channel adapter 23. The information setting unit 31 can also automatically specify “Multiplicity (operable number)” of the disk information table 27 using the type and capacity of the disk.

Referring back to FIG. 2, the multiplicity monitoring unit 32 monitors current multiplicity of the data copy currently executed on the line, for each remote line. The multiplicity monitoring unit 32 monitors current multiplicity of access executed to a RAID group, for each RAID group of a copy source. Moreover, the multiplicity monitoring unit 32 monitors current multiplicity of access executed to a RAID group, for each RAID group of a copy destination. The multiplicity monitoring unit 32 may always monitor multiplicity, may periodically monitor it, or may monitor it at a timing of starting data copy, after the disk array device 20 is activated.

For example, the multiplicity monitoring unit 32 monitors the number of executed copy sessions for each remote line. As one example, when a copy session is newly executed, the multiplicity monitoring unit 32 increments “Multiplicity (number of operations)” stored in the remote line table 26 in association with the executed remote line. When the executed copy session is ended, the multiplicity monitoring unit 32 decrements “Multiplicity (number of operations)” stored in the remote line table 26 in association with the ended remote line. The case where the copy session is newly executed indicates a case where an unexecuted session is executed or a case where a session is already executed but is incompletely ended is newly executed.

More specifically, when a copy session “ID=01” is executed, the multiplicity monitoring unit 32 refers to the session information table 28, to specify a copy destination device “B”. Subsequently, the multiplicity monitoring unit 32 increments “Multiplicity (number of operations)” of the remote line “0” connected with the specified copy destination device “B” in the remote line table 26. Likewise, when the copy session “ID=01” is ended, the multiplicity monitoring unit 32 refers to the session information table 28, to specify the copy destination device “B”. Subsequently, the multiplicity monitoring unit 32 decrements “Multiplicity (number of operations)” of the remote line “0” connected with the specified copy destination device “B” in the remote line table 26.

The multiplicity monitoring unit 32 counts accesses or the like to a RAID group formed with the disk group 21 of the own device being the copy source, and stores the counted number of accesses as the number of operations in the disk information table 27. That is, the multiplicity monitoring unit 32 monitors the accesses to a RAID group, set as the copy source or as the copy destination, formed in the disk group 21 of the own device, and also monitors the accesses such as data write and data read to and from the RAID group.

For example, it is assumed that in the multiplicity monitoring unit 32, a copy session is newly executed to the RAID group of the disk group 21 as a copy source. In this case, the multiplicity monitoring unit 32 increments “Multiplicity (number of operations)” stored in the disk information table 27 in association with the executed RAID group. In addition, when the executed copy session is ended, the multiplicity monitoring unit 32 decrements “Multiplicity (number of operations)” stored in the disk information table 27 in association with the ended RAID group.

More specifically, in the multiplicity monitoring unit 32, it is assumed that a copy session of “Device ID=Z, RAID group=001” is executed by the transfer executing unit 37. In this case, the multiplicity monitoring unit 32 increments “Multiplicity (number of operations)” of “Device ID=Z, RAID group=001” in the disk information table 27. In addition, when the copy session of “Device ID=Z, RAID group=001” is ended, the multiplicity monitoring unit 32 decrements “Multiplicity (number of operations)” of “Device ID=Z, RAID group=001” in the disk information table 27.

As one example, when the copy session “ID=01” is executed, the multiplicity monitoring unit 32 specifies copy-source LUN “0x01” from the session information table 28. Subsequently, the multiplicity monitoring unit 32 specifies the RAID group “001” corresponding to the copy source device “Z” being the own device and to the copy-source LUN “0x01” from the disk information table 27, and increments “Multiplicity (number of operations)” of the specified RAID group. Likewise, when the copy session “ID=01” is ended, the multiplicity monitoring unit 32 specifies the copy-source LUN “0x01” from the session information table 28. Subsequently, the multiplicity monitoring unit 32 specifies the RAID group “001” corresponding to the copy source device “Z” and the copy-source LUN “0x01” from the disk information table 27, and decrements “Multiplicity (number of operations)” of the specified RAID group.

The multiplicity monitoring unit 32 counts accesses or the like to a RAID group of the copy destination device, and stores the counted number of accesses as the number of operations in the disk information table 27. That is, the multiplicity monitoring unit 32 monitors the accesses to a RAID group, set as the copy source or as the copy destination, formed in the copy destination device, and also monitors the accesses such as data write and data read to and from the RAID group. More specifically, the multiplicity monitoring unit 32 periodically receives the number of accesses to the RAID group from the copy destination device and monitors the number of accesses to the RAID group of the copy destination device. It should be noted that the method for monitoring the number of accesses to the RAID group of the copy destination device is not limited thereto and thus various known methods can be used.

For example, it is assumed that in the multiplicity monitoring unit 32, a copy session is newly executed to the RAID group of the copy destination device as a copy destination. In this case, the multiplicity monitoring unit 32 increments “Multiplicity (number of operations)” stored in the disk information table 27 in association with the RAID group being the copy destination. In addition, when the executed copy session is ended, the multiplicity monitoring unit 32 decrements “Multiplicity (number of operations)” stored in the disk information table 27 in association with the ended RAID group being the copy destination.

More specifically, in the multiplicity monitoring unit 32, it is assumed that a copy session of “Device ID=A, RAID group=001” is executed by the transfer executing unit 37. In this case, the multiplicity monitoring unit 32 increments “Multiplicity (number of operations)” of “Device ID=A, RAID group=001” in the disk information table 27. In addition, when the copy session of “Device ID=A, RAID group=001” is ended, the multiplicity monitoring unit 32 decrements “Multiplicity (number of operations)” of “Device ID=A, RAID group=001” in the disk information table 27.

As one example, when the copy session “ID=01” is executed, the multiplicity monitoring unit 32 specifies copy-destination LUN “0x01” and the copy destination device “B” from the session information table 28. Subsequently, the multiplicity monitoring unit 32 specifies the RAID group “001” corresponding to the copy destination device “B” and the copy-destination LUN “0x01” from the disk information table 27, and increments “Multiplicity (number of operations)” of the specified RAID group. Likewise, when the copy session “ID=01” is ended, the multiplicity monitoring unit 32 specifies the copy-destination LUN “0x01” and the copy destination device “B” from the session information table 28. Subsequently, the multiplicity monitoring unit 32 specifies the RAID group “001” corresponding to the copy destination device “B” and the copy-destination LUN “0x01” from the disk information table 27, and decrements “Multiplicity (number of operations)” of the specified RAID group.

Moreover, the multiplicity monitoring unit 32 checks communication of a REC path using the known technology such as PING and polling, and monitors a status of the REC path. When such an abnormal REC path that communication cannot be performed is detected, the multiplicity monitoring unit 32 changes “REC path (status)” of the remote line table 26 corresponding to the REC path, to “abnormal”. The “REC path (status)” may be updated by the manager or the like through the information setting unit 31.

Referring back to FIG. 2, the session generating unit 33 receives an operation by the manager or the like, generates a copy session, and stores the generated copy session in the session information table 28. For example, the session generating unit 33 receives “Copy-source LUN, Copy-destination LUN, Copy destination device, and Copy type” from the manager terminal connected thereto through other interface such as the channel adapter 23 and the LAN. The session generating unit 33 allocates “Session ID” to the received information and stores the information in the session information table 28. The session generating unit 33 not only receives the information from the manager terminal or the like, but also automatically generates the information by a scheduler function of backup software, and can store the generated information in the session information table 28.

When data copy is to be executed, the remote-line determining unit 34 acquires an upper limit stored in the remote line table 26 in association with the remote line which is connected with the copy destination device of the data copy. The remote-line determining unit 34 then determines whether execution of the data copy does not cause the multiplicity to exceed the upper limit, based on the acquired upper limit and the current multiplicity of data currently copied using the remote line.

For example, when reaching a timing in which data copy is executed, the remote-line determining unit 34 determines one remote line as a target line. Subsequently, the remote-line determining unit 34 extracts copy sessions that use the determined remote line from the session information table 28. The remote-line determining unit 34 then acquires the upper limit of the number of operations of the determined remote line from the remote line table 26, and acquires the number of operations being the number of data copies currently executed on the remote line. Subsequently, when it is determined that the number of operations does not exceed the upper limit even if copying is newly executed, the remote-line determining unit 34 selects one copy session from the extracted copy sessions, and outputs the selected one to the copy-source determining unit 35.

As one example, the remote-line determining unit 34 specifies a remote line having the remote line ID “0” as a determination target line. In this case, the remote-line determining unit 34 detects “B” as “Copy destination device” corresponding to “Remote line ID=0”. Subsequently, the remote-line determining unit 34 extracts “01” and “03” as the copy session in which “Copy destination device” is “B”, from the session information table 28.

The remote-line determining unit 34 acquires “Operable number=20” and “Number of operations=5” corresponding to “Remote line ID=0” from the remote line table 26. Even if the copy session of “Session ID=01” is executed, “Number of operations” is “6” which does not exceed “Operable number=20”, and therefore the remote-line determining unit 34 determines that the copy session can be executed. Thereafter, the remote-line determining unit 34 outputs “Session ID=01” to the copy-source determining unit 35. When the session information table 28 stores “Status”, the remote-line determining unit 34 sequentially determines copy sessions whose “Status” is “Unexecuted” or “Abnormally ended” as targets to be executed. As another example, when the session of which execution is ended is removed from the session information table 28, the remote-line determining unit 34 sequentially determines copy sessions stored in the session information table 28 as targets to be executed.

When it is determined that the execution of a new copy session causes “Number of operations” to exceed “Operable number”, the remote-line determining unit 34 stops copy execution of the copy session. The remote-line determining unit 34 then determines whether execution of the copy session does not cause the multiplicity to exceed the upper limit, for any other remote line stored in the remote line table 26.

That is, the remote-line determining unit 34 executes the processes until the number of operations for the remote line having “Remote line ID=0” exceeds the upper limit or until no target copy session remains. When a series of the processes for the copy session corresponding to “Remote line ID=0” is executed, the remote-line determining unit 34 shifts to the processes for other remote line.

The copy-source determining unit 35 acquires the upper limit of a RAID group being a copy source and the current multiplicity of access to the RAID group, from the disk information table 27. The copy-source determining unit 35 then determines whether execution of new data transfer does not cause the multiplicity for the RAID group to exceed the upper limit. That is, the copy-source determining unit 35 determines whether the load of the RAID group becoming the copy source falls within an allowable range.

For example, the copy-source determining unit 35 specifies “Copy-source LUN” corresponding to the copy session selected by the remote-line determining unit 34 from the session information table 28. The copy-source determining unit 35 then specifies “RAID group” to which the specified “Copy-source LUN” belongs, from the disk information table 27.

Thereafter, the copy-source determining unit 35 acquires “Operable number” and “Number of operations” corresponding to the specified “RAID group” from the disk information table 27, and determines whether execution of new data copy does not cause the number of operations to exceed the upper limit. When it is determined that the number of operations does not exceed the upper limit even if the new data copy is executed, the copy-source determining unit 35 outputs the copy session as a target to be determined to the copy-destination determining unit 36.

As one example, when receiving “Session ID=01” from the remote-line determining unit 34, the copy-source determining unit 35 specifies that the “Copy-source LUN” corresponding to the “Session ID=01” is “0x01”, from the session information table 28. Subsequently, the copy-source determining unit 35 specifies that “RAID group” to which “Copy-source LUN=0x01” belongs is “001” in the “Device ID=Z” being the own device, from the disk information table 27.

Thereafter, the copy-source determining unit 35 acquires “Operable number=10” and “Number of operations=2” corresponding to the “RAID group=001” of the “Device ID=Z”. Even if the copy session of “Session ID=01” is executed, the “Number of operations” is “3”, which does not exceed “Operable number=10”, and thus the copy-source determining unit 35 determines that this copy session can be executed. Thereafter, the copy-source determining unit 35 outputs “Session ID=01” to the copy-destination determining unit 36.

The copy-destination determining unit 36 acquires the upper limit of a RAID group becoming a copy destination and current multiplicity of the current access to the RAID group, from the disk information table 27. The copy-destination determining unit 36 then determines whether execution of new data transfer does not cause the multiplicity for the RAID group to exceed the upper limit. That is, the copy-destination determining unit 36 determines whether the load of the RAID group becoming the copy destination falls within an allowable range.

For example, the copy-destination determining unit 36 specifies “Copy-destination LUN” being the copy destination corresponding to the copy session selected by the remote-line determining unit 34, from the session information table 28. The copy-destination determining unit 36 then specifies “RAID group” of the copy destination to which the specified “Copy-destination LUN” belongs, from the disk information table 27.

Thereafter, the copy-destination determining unit 36 acquires “Operable number” and “Number of operations” corresponding to the “RAID group” of the copy destination from the disk information table 27, and determines whether execution of new data copy does not cause the multiplicity to exceed the upper limit. When it is determined that the multiplicity does not exceed the upper limit even if the new data copy is executed, then the copy-destination determining unit 36 outputs the copy session as a target to be determined to the transfer executing unit 37.

As one example, when receiving “Session ID=01” from the copy-source determining unit 35, the copy-destination determining unit 36 specifies that the “Copy-destination LUN” corresponding to the “Session ID=01” is “0x01” of “Copy destination device=B”, from the session information table 28. Subsequently, the copy-destination determining unit 36 specifies that “RAID group” to which “Copy-destination LUN=0x01” of “Copy destination device=B” belongs is “001”, from the disk information table 27.

Thereafter, the copy-destination determining unit 36 acquires “Operable number=5” and “Number of operations=0” corresponding to the “RAID group=001” of “Copy destination device=B”. Even if the copy session of “Session ID=01” is executed, the “Number of operations” is “1”, which does not exceed “Operable number=5”, and thus the copy-destination determining unit 36 determines that this copy session can be executed. Thereafter, the copy-destination determining unit 36 outputs “Session ID=01” to the transfer executing unit 37.

When it is determined by the remote-line determining unit 34, the copy-source determining unit 35, and by the copy-destination determining unit 36 that the number of operations does not exceed the upper limit, the transfer executing unit 37 executes the data copy. For example, when receiving “Session ID=01” from the copy-destination determining unit 36, the transfer executing unit 37 specifies “Remote line=0” corresponding to “Session ID=01” from the remote line table 26. Subsequently, the transfer executing unit 37 specifies “REC path=0x00, 0x02, 0x04, 0x06” corresponding to “Remote line=0”, from the remote line table 26. Thereafter, the transfer executing unit 37 uses an arbitrary REC path among the specified REC paths to execute “Session ID=01”. For example, the transfer executing unit 37 uses “REC path=0x00” to execute data copy from “LUN=0x01” of the disk group 21 of the own device to “LUN=0x01” of the disk array device B being the copy destination.

That is, when each of the load status of the remote line, the load status of the RAID group as the copy source, and the load status of the RAID group as the copy destination is within the allowable range, the transfer executing unit 37 executes data copy. The transfer executing unit 37 deletes the copy session of executed “Session ID=01” from the session information table 28, and saves it to the other area of the memory 25. For example, when the copy session for executing 100-GB copy is divided into 100 portions by 1 GB and is executed and if all the executions are completed, the transfer executing unit 37 deletes the copy session from the session information table 28. As another method, 100 copy sessions are generated 1 GB by 1 GB, and if execution of one of them is completed, then one copy session is deleted from the session information table 28.

Flow of Process

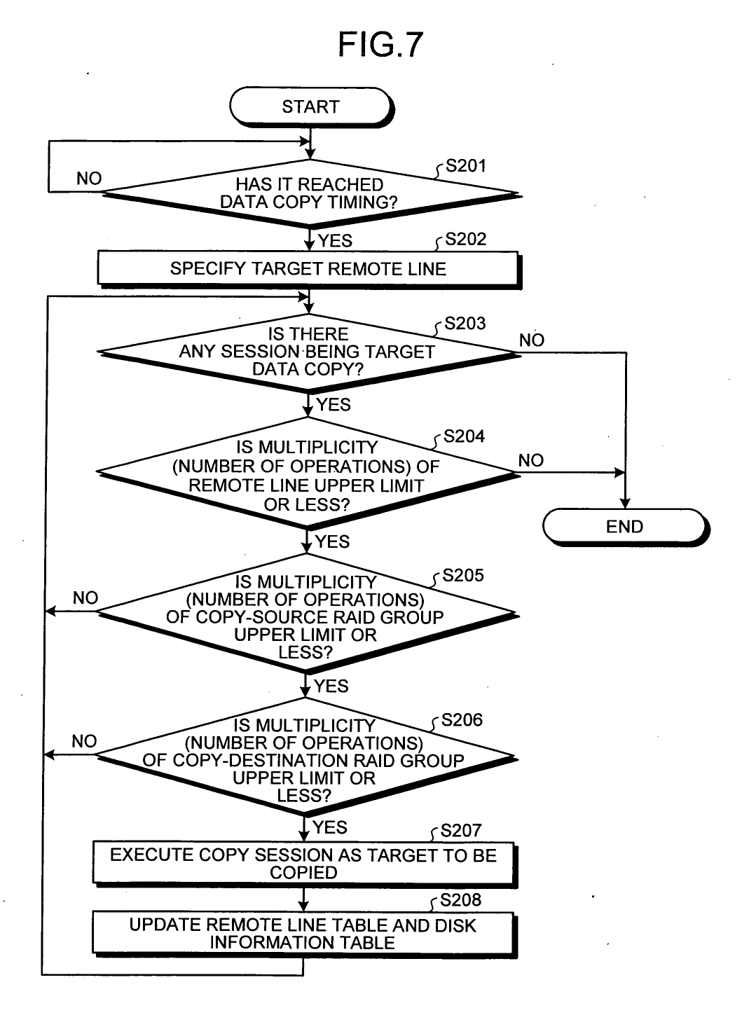

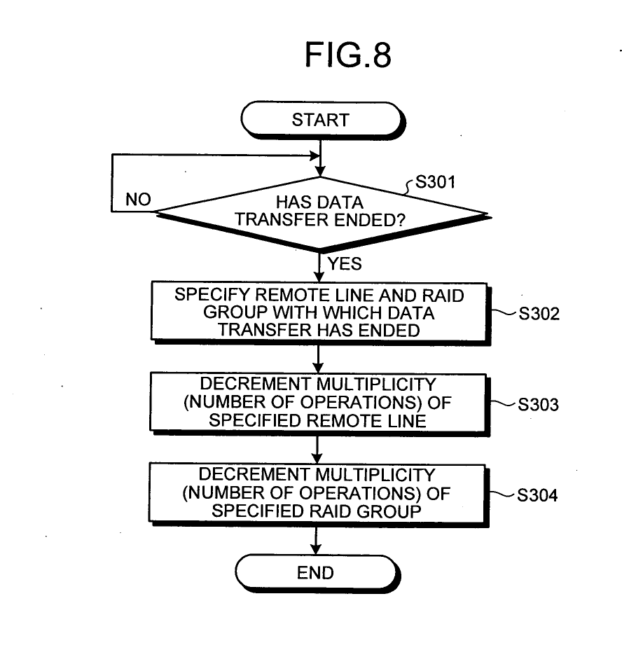

Next, each flow of processes in a disk array device 20 will be explained with reference to FIG. 6 through FIG. 8. FIG. 6 is a flowchart representing a flow of a REC-path generation process according to the second embodiment. FIG. 7 is a flowchart representing a flow of a data copy execution process according to the second embodiment. FIG. 8 is a flowchart representing a flow of a process after the data copy is executed according to the second embodiment.

Flow of REC-Path Generation Process

First, examples of generating the remote line table 26 and the disk information table 27 represented in FIG. 2 are explained with reference to FIG. 6. As represented in FIG. 6, when receiving an instruction to generate a path from a manager terminal or the like connected thereto via the channel adapter 23 (Yes at Step S101), the information setting unit 31 of the disk array device 20 executes Step S102.

More specifically, the information setting unit 31 receives “Remote line ID, Copy destination devices 1 to N, Multiplicity (operable number), REC path (ID, status)”, and stores the received information in the remote line table 26 as a correspondence between the REC path and the remote line or the like.

Then, the information setting unit 31 acquires disk information from the control unit 30 of the own device and each of copy destination devices (Step S103). For example, the information setting unit 31 acquires “Device ID, RAID group, LUN, and Multiplicity (operable number)” of the own device from the RAID controller provided in the control unit 30. In addition, the information setting unit 31 connects to each of the copy destination devices and acquires “Device ID, RAID group, LUN, and Multiplicity (operable number)” set in each of the copy destination devices.

Thereafter, the information setting unit 31 generates the disk information table 27 from the disk information for the own device and the disk information for the copy destination device acquired at Step S103 (Step S104).

Flow of Data Copy Execution Process

Next, the flow of the data copy execution process will be explained with reference to FIG. 7. This process is executed for each remote line. More specifically, the disk array device 20 may execute sequentially or may execute in parallel the process in FIG. 7 for remote lines stored in the remote line table 26.

As represented in FIG. 7, when it has reached data copy timing indicating a timing of executing the data copy (Yes at Step S201), the remote-line determining unit 34 specifies a remote line as a target to be processed from the remote line table 26 (Step S202). For example, the remote-line determining unit 34 specifies an unexecuted remote line at the current data copy timing.

Then, the remote-line determining unit 34 refers to the session information table 28 to determine whether there is any copy session that uses the remote line specified at Step S202 (Step S203). For example, the remote-line determining unit 34 selects one from among unexecuted copy sessions in the session information table 28, and specifies a copy destination device for the selected copy session. Subsequently, the remote-line determining unit 34 specifies a remote line connected to the specified copy destination device from the remote line table 26. Thereafter, the remote-line determining unit 34 determines whether there is any copy session that uses the remote line specified at Step S202 depending on whether the specified remote line is a remote line as a target to be processed.

When it is determined that there is a copy session (Yes at Step S203), the remote-line determining unit 34 further determines whether the number of operations on the remote line specified at Step S202 becomes the operable number or less even if the new copy session is executed (Step S204). At this time, the remote-line determining unit 34 extracts the copy session that uses the remote line specified at Step S202 from the session information table 28 and stores the copy session in the memory 25 or the like.

When it is determined by the remote-line determining unit 34 that the number of operations on the remote line specified at Step S202 becomes the operable number or less (Yes at Step S204), the copy-source determining unit 35 executes Step S205. More specifically, the copy-source determining unit 35 specifies a copy-source RAID group based on the extracted copy session, and determines whether the number of operations of the specified copy-source RAID group becomes the operable number or less.

When it is determined by the copy-source determining unit 35 that the number of operations of the copy-source RAID group becomes the operable number or less (Yes at Step S205), the copy-destination determining unit 36 executes Step S206. More specifically, the copy-destination determining unit 36 specifies a copy-destination RAID group based on the extracted copy session, and determines whether the number of operations of the specified copy-destination RAID group becomes the operable number or less.

When it is determined by the copy-destination determining unit 36 that the number of operations of the copy-destination RAID group becomes the operable number or less (Yes at Step S206), the transfer executing unit 37 executes the copy session as a target to be processed (Step S207). Subsequently, the multiplicity monitoring unit 32 updates “Number of operations of Remote line” in the remote line table 26, and updates “Number of operations of the copy-source RAID group” and “Number of operations of the copy-destination RAID group” in the disk information table 27 (Step S208). Thereafter, the disk array device 20 repeats the processes at Step S203 and thereafter.

When it is determined by the copy-source determining unit 35 that the number of operations of the copy-source RAID group becomes larger than the operable number (No at Step S205), the disk array device 20 executes the processes at Step S203 and thereafter for the next copy session. Likewise, when it is determined by the copy-destination determining unit 36 that the number of operations of the copy-destination RAID group becomes larger than the operable number (No at Step S206), the disk array device 10 executes the processes at Step S203 and thereafter for the next copy session.

When it is determined by the remote-line determining unit 34 that the number of operations of the remote line becomes larger than the operable number (No at Step S204), the disk array device 20 ends the process, and executes the processes at Step S201 and thereafter for the next remote line. Likewise, when it is determined by the remote-line determining unit 34 that there is no copy session as a target to be copied (No at Step S203), the disk array device 20 ends the process and executes the processes at Step S201 and thereafter for the next remote line.

Flow of Process After Execution of Data Copy

Next, the flow of the process after execution of data copy is explained with reference to FIG. 8. This process is executed each time end of data copy is detected.

As represented in FIG. 8, when detecting the copy session in which data transfer has ended (Yes at Step S301), the multiplicity monitoring unit 32 of the disk array device 20 executes Step S302. More specifically, the multiplicity monitoring unit 32 specifies “Remote line”, “RAID group of copy source”, and “RAID group of copy destination” used by the copy session, from the copy session in which data copy has ended.

Then, the multiplicity monitoring unit 32 updates “Number of operations” of “Remote line” specified at Step S302 in the remote line table 26 (Step S303). Likewise, the multiplicity monitoring unit 32 updates “Number of operations” of “RAID group of copy source” and “Number of operations” of “RAID group of copy destination” specified at Step S302 in the disk information table 27 (Step S304).

Effect Due to Second Embodiment

As explained above, according to the second embodiment, the disk array device 20 stores therein the upper limit of multiplicity capable of performing multiple access to the RAID group for each RAID group formed by the disk group 21. When the copy session is to be executed, the disk array device 20 acquires the upper limit stored in association with the RAID group becoming a transfer source and also acquires current multiplicity of the current access to the RAID group. The disk array device 20 then determines whether execution of the copy session does not cause the multiplicity for the RAID group to exceed the upper limit. Thereafter, when it is determined that the multiplicity does not exceed the upper limit, the disk array device 20 executes the copy session.

The disk array device 20 stores therein the upper limit of multiplicity capable of performing multiple access to the RAID group for each RAID group formed by the copy destination device. When the copy session is to be executed, the disk array device 20 acquires the upper limit stored in association with the RAID group becoming a copy destination and also acquires current multiplicity of the current access to the RAID group. The disk array device 20 then determines whether execution of the copy session does not cause the multiplicity for the RAID group to exceed the upper limit. Thereafter, when it is determined that the multiplicity does not exceed the upper limit, the disk array device 20 executes the copy session.

The disk array device 20 monitors the number of operations of the remote line used for copy and can thereby monitor the load status of the remote line. When the number of operations of the remote line is the upper limit or less, or when the load status of the remote line is within an allowable range, the disk array device 20 executes data copy. As a result, the data copy can be executed with the multiplicity suitable for the line.

The disk array device 20 monitors the multiplicity for each remote line and can thereby monitor the multiplicity of each of the remote lines even when a plurality of remote lines are provided between disk array devices or even when a connection configuration of disk array devices is one-to-N. As a result, even if there is a one-to-N connection between a copy source and copy destinations, the disk array device 20 can transfer the data with the multiplicity suitable for each line.

The disk array device 20 also monitors the multiplicity of the RAID group of a data copy source and the multiplicity of the RAID group of a copy destination. That is, the disk array device 20 monitors all the disk accesses including copying executed to each of the RAID groups. Therefore, the disk array device 20 can prevent a remote-line busy state due to overload of the RAID group and efficiently use the remote lines. For example, the remote line can be prevented from being occupied caused by waiting of response of data copy due to overload of the RAID group as the copy destination. If the copy-destination RAID group is overloaded, the data copy into the RAID group is stopped, so that high priority can be given to data copy for any other RAID group which is not overloaded.

### [c] Third Embodiment

Incidentally, the disk array device disclosed in the present embodiment monitors any multiplicity other than the multiplicity of the remote line and the multiplicity of the RAID group, so that the disk array device can control the data copy. In a third embodiment, therefore, an example of controlling data copy based on the multiplicity of a copy-destination LUN and the multiplicity of a copy-source LUN will be explained.

Here, based on the multiplicity of a copy-destination LUN and the multiplicity of a copy-source LUN in addition to the multiplicity of a remote line and the multiplicity of a RAID group explained in the second embodiment, the example of controlling data copy will be explained.

REC-Path Generation Process

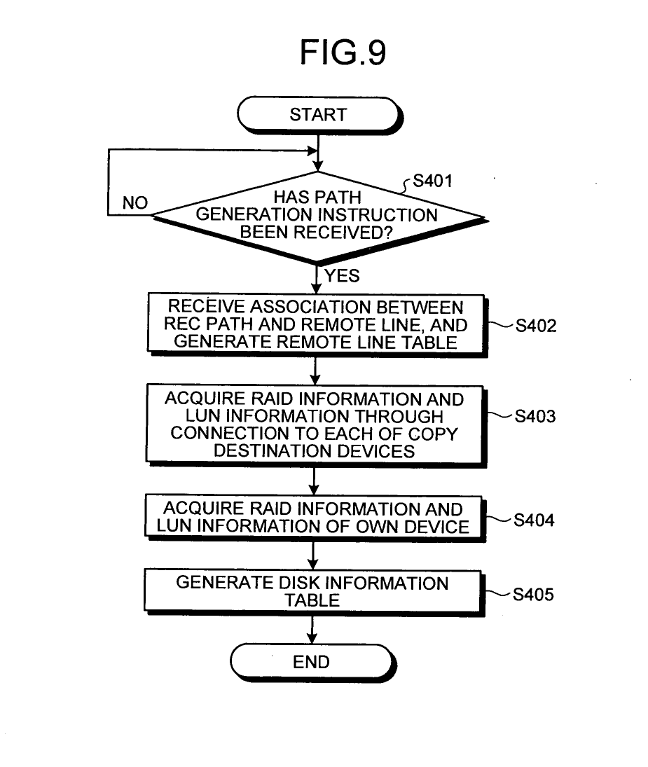

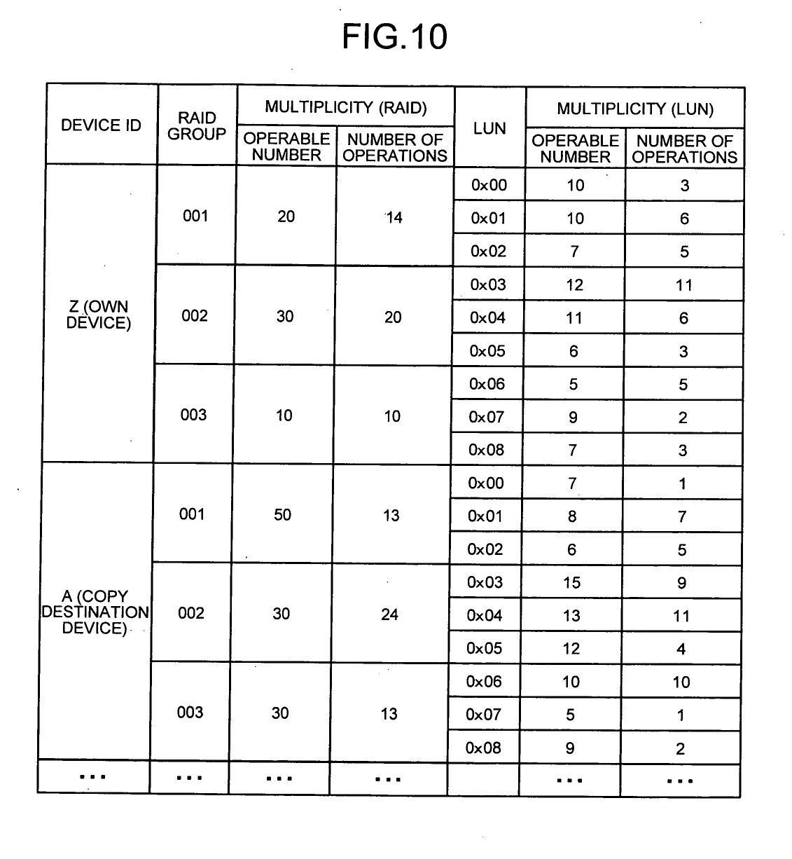

First, a flow of a REC-path generation process according to the third embodiment will be explained with reference to FIG. 9 and FIG. 10. FIG. 9 is a flowchart representing a flow of the REC-path generation process according to the third embodiment.

As represented in FIG. 9, when receiving a path generation instruction from a manager terminal or the like connected thereto via the channel adapter 23 (Yes at Step S401), the information setting unit 31 of the disk array device 20 executes Step S402.

More specifically, the information setting unit 31 receives “Remote line ID, Copy destination devices 1 to N, Multiplicity (operable number), and REC path (ID, status)” and stores them in the remote line table 26 as a correspondence between the REC path and the remote line or the like.

Then, the information setting unit 31 acquires disk information such as RAID and LUN from each of the copy destination devices (Step S403). For example, the information setting unit 31 connects to each of the copy destination devices and acquires “Device ID, RAID group, LUN, Operable number of multiplicity (RAID), and Operable number of multiplicity (LUN)” set in each of the copy destination devices.

The information setting unit 31 also acquires disk information such as RAID and LUN of the own device from the RAID controller provided in the control unit 30 of the own device (Step S404). For example, the information setting unit 31 acquires “Device ID, RAID group, LUN, Operable number of multiplicity (RAID), and Operable number of multiplicity (LUN)” formed in the disk group 21 of the own device.

Thereafter, the information setting unit 31 generates the disk information table 27 from the disk information for each of the copy destination devices acquired at Step S403 and the disk information for the own device acquired at Step S404 (Step S405).

Structure of Disk Information Table

Next, an example of a structure of a disk information table generated by implementing the process in FIG. 8 will be explained with reference to FIG. 10. FIG. 10 is a diagram representing an example of disk information stored in a disk information table according to the third embodiment.

As represented in FIG. 10, a disk information table 27 according to the third embodiment stores therein “Device ID, RAID group, Operable number and Number of operations of multiplicity (RAID), LUN, and Operable number and Number of operations of multiplicity (LUN)”.

The “Device ID” stored herein is an identifier such as a host name for uniquely identifying its own device or a copy-destination disk array device. The “RAID group” is an identifier for identifying a RAID group formed in the disk group 21 or in a copy destination device, and also an identifier for identifying a group forming one logical disk in combination of physical disks.

The “Operable number of multiplicity (RAID)” is an upper limit of multiplicity capable of accessing the RAID group. The “Number of operations of multiplicity (RAID)” is current multiplicity of the current access to the RAID group.

The “LUN” is an identifier for identifying a logical volume in the disk group 21 or in the copy destination device, and is a unit recognized as a logical disk created by one from the RAID group or created by dividing the RAID group into a plurality of portions.

The “Operable number of multiplicity (LUN)” is an upper limit of multiplicity capable of accessing the LUN. That is, this “Operable number of multiplicity (LUN)” is not limited to the number of copy operations, but is the concurrently executable number of various disk accesses such as data write and data read, and indicates a maximum load allowable for the LUN. The “Operable number of multiplicity (LUN)” is uniquely determined by the type and the capacity of the disk.

The “Number of operations of multiplicity (LUN)” is current multiplicity indicating the number of current accesses to the LUN. That is, the “Number of operations of multiplicity (LUN)” is the number of disk accesses indicating concurrent accesses at the moment, including the number of copy operations, reference to data, and data write, or the like, which indicates a load at the present time of the LUN.

In the case of FIG. 10, the own device having “Device ID=Z” is formed with RAID groups of “001”, “002”, and “003”. In the RAID group of “001”, “20” is set as the upper limit of operable multiplicity, and 14 data communications are currently being executed. The RAID group of “001 is formed with three LUNs having “ID=0x00, 0x01, 0x02”. In the LUN [ID=0x00], “10” is set as the upper limit of operable multiplicity, and three data communications are currently being executed. In the LUN [ID=0x01], “10” is set as the upper limit of operable multiplicity, and six data communications are currently being executed. In the LUN [ID=0x02], “7” is set as the upper limit of operable multiplicity, and five data communications are currently being executed.

In the RAID group of “002” in the own device having “Device ID=Z”, “30” is set as the upper limit of operable multiplicity, and 20 data communications are currently being executed. The RAID group of “002” is formed with three LUNs having “ID=0x03, 0x04, 0x05”. In the LUN [ID=0x03], “12” is set as the upper limit of operable multiplicity, and 11 data communications are currently being executed. In the LUN [ID=0x04], “11” is set as the upper limit of operable multiplicity, and six data communications are currently being executed. In the LUN [ID=0x05], “6” is set as the upper limit of operable multiplicity, and three data communications are currently being executed.

In the RAID group of “003” in the own device having “Device ID=Z”, “10” is set as the upper limit of operable multiplicity, and 10 data communications are currently being executed. The RAID group of “003” is formed with three LUNs having “ID=0x06, 0x07, 0x08”. In the LUN [ID=0x06], “5” is set as the upper limit of operable multiplicity, and five data communications are currently being executed. In the LUN [ID=0x07], “9” is set as the upper limit of operable multiplicity, and two data communications are currently being executed. In the LUN [ID=0x08], “7” is set as the upper limit of operable multiplicity, and three data communications are currently being executed.

In the case of FIG. 10, the copy destination device having “Device ID=A” is formed with RAID groups of “001”, “002”, and “003”. In the RAID group of “001”, “50” is set as the upper limit of operable multiplicity, and 13 data communications are currently being executed. The RAID group of “001 is formed with three LUNs having “ID=0x00, 0x01, 0x02”. In the LUN [ID=0x00], “7” is set as the upper limit of operable multiplicity, and one data communication is currently being executed. In the LUN [ID=0x01], “8” is set as the upper limit of operable multiplicity, and seven data communications are currently being executed. In the LUN [ID=0x02], “6” is set as the upper limit of operable multiplicity, and five data communications are currently being executed.

In the RAID group of “002” in the copy destination device having “Device ID=A”, “30” is set as the upper limit of operable multiplicity, and 24 data communications are currently being executed. The RAID group of “002” is formed with three LUNs having “ID=0x03, 0x04, 0x05”. In the LUN [ID=0x03], “15” is set as the upper limit of operable multiplicity, and nine data communications are currently being executed. In the LUN [ID=0x04], “13” is set as the upper limit of operable multiplicity, and 11 data communications are currently being executed. In the LUN [ID=0x05], “12” is set as the upper limit of operable multiplicity, and four data communications are currently being executed.

In the RAID group of “003” in the copy destination device having “Device ID=A”, “30” is set as the upper limit of operable multiplicity, and 13 data communications are currently being executed. The RAID group of “003” is formed with three LUNs having “ID=0x06, 0x07, 0x08”. In the LUN [ID=0x06], “10” is set as the upper limit of operable multiplicity, and 10 data communications are currently being executed. In the LUN [ID=0x07], “5” is set as the upper limit of operable multiplicity, and one data communication is currently being executed. In the LUN [ID=0x08], “9” is set as the upper limit of operable multiplicity, and two data communications are currently being executed.

Flow of Data Copy Execution Process

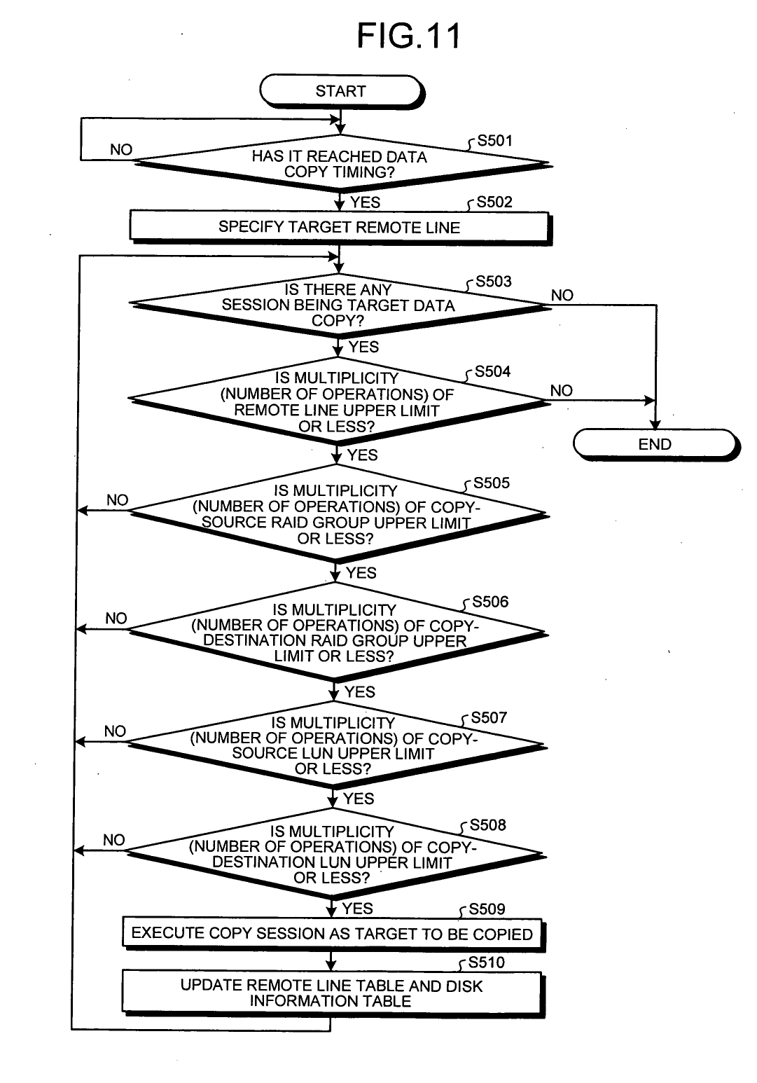

Next, a flow of a data copy execution process according to the third embodiment will be explained with reference to FIG. 11. FIG. 11 is a flowchart representing the flow of the data copy execution process according to the third embodiment. The process is executed for each remote line similarly to FIG. 7.

As represented in FIG. 11, when it has reached data copy timing (Yes at Step S501), the remote-line determining unit 34 of the disk array device 20 specifies a remote line as a target to be processed from the remote line table 26 (Step S502).

Then, the remote-line determining unit 34 refers to the session information table 28 to determine whether there is any copy session that uses the remote line specified at Step S502 (Step S503).

When it is determined that there is a copy session (Yes at Step S503), the remote-line determining unit 34 further determines whether the number of operations on the remote line specified at Step S502 becomes the operable number or less (Step S504). At this time, the remote-line determining unit 34 extracts the copy session that uses the remote line specified at Step S502 from the session information table 28 and stores the copy session in the memory 25 or the like.

When it is determined by the remote-line determining unit 34 that the number of operations on the remote line becomes the operable number or less (Yes at Step S504), the copy-source determining unit 35 executes Step S505. More specifically, the copy-source determining unit 35 specifies a copy-source RAID group based on the extracted copy session, and determines whether the number of operations of the specified copy-source RAID group becomes the operable number or less.

When it is determined by the copy-source determining unit 35 that the number of operations of the copy-source RAID group becomes the operable number or less (Yes at Step S505), the copy-destination determining unit 36 executes Step S506. More specifically, the copy-destination determining unit 36 specifies a copy-destination RAID group based on the extracted copy session, and determines whether the number of operations of the specified copy-destination RAID group becomes the operable number or less.

When it is determined by the copy-destination determining unit 36 that the number of operations of the copy-destination RAID group becomes the operable number or less (Yes at Step S506), the copy-source determining unit 35 executes Step S507. More specifically, the copy-source determining unit 35 specifies a copy-source LUN based on the extracted copy session, and determines whether the number of operations of the specified copy-source LUN becomes the operable number or less.

For example, when receiving “Session ID=01” from the remote-line determining unit 34, the copy-source determining unit 35 specifies that “Copy-source LUN” corresponding to “Session ID=01” is “0x01” of “Device ID=Z” being the own device, from the session information table 28. Subsequently, the copy-source determining unit 35 acquires “Operable number=10” and “Number of operations=6” corresponding to “Copy-source LUN=0x01” of “Device ID=Z”. Even if the copy session of “Session ID=01” is executed, the “Number of operations” is 7, which does not exceed “Operable number=10”, and thus the copy-source determining unit 35 determines that the copy session can be executed. Thereafter, the copy-source determining unit 35 outputs “Session ID=01” to the copy-destination determining unit 36.

Referring back to FIG. 11, when it is determined by the copy-source determining unit 35 that the number of operations of the copy-source LUN becomes the operable number or less (Yes at Step S507), the copy-destination determining unit 36 executes Step S508. More specifically, the copy-destination determining unit 36 specifies a copy-destination LUN based on the extracted copy session, and determines whether the number of operations of the specified copy-destination LUN becomes the operable number or less.

For example, when receiving “Session ID=01” from the copy-source determining unit 35, the copy-destination determining unit 36 specifies that “Copy-destination LUN” corresponding to “Session ID=01” is “0x01” of “Device ID=A” from the session information table 28. Subsequently, the copy-source determining unit 35 acquires “Operable number=8” and “Number of operations=7” corresponding to “Copy-source LUN=0x01” of “Device ID=Z”. Even if the copy session of “Session ID=01” is executed, the “Number of operations” is “8”, which does not exceed “Operable number=10”, and thus the copy-source determining unit 35 determines that the copy session can be executed. Thereafter, the copy-source determining unit 35 outputs “Session ID=01” to the transfer executing unit 37.

Referring back to FIG. 11, when it is determined by the copy-destination determining unit 36 that the number of operations of the copy-destination LUN becomes the operable number or less (Yes at Step S508), the transfer executing unit 37 executes the copy session as a target to be processed (Step S509). Subsequently, the multiplicity monitoring unit 32 updates “Number of operations of remote line” in the remote line table 26, and updates “Number of operations of the copy-source RAID group” and “Number of operations of the copy-destination RAID group” in the disk information table 27 (Step S510). At this time, the multiplicity monitoring unit 32 also updates “Number of operations of copy-source LUN” and “Number of operations of copy-destination LUN” in the disk information table 27. Thereafter, the disk array device 20 repeats the processes at Step S503 and thereafter.

When it is determined by the copy-destination determining unit 36 that the number of operations of the copy-destination LUN is greater than the operable number (No at Step S508), the disk array device 20 returns to Step S503, and executes the processes at Step S503 and thereafter for the next copy session. Likewise, when it is determined by the copy-source determining unit 35 that the number of operations of the copy-source LUN is greater than the operable number (No at Step S507), the disk array device 20 returns to Step S503, and executes the processes at Step S503 and thereafter for the next copy session.

It should be noted that the processes after the steps of “No at Step S506”, “No at Step S505”, “No at Step S504”, and “No at Step S503” are the same as these after the steps of “No at Step S206”, “No at Step S205”, “No at Step S204”, and “No at Step S203”, and thus detailed explanation thereof is omitted.

Effect Due to Second Embodiment

As explained above, according to the third embodiment, the disk array device 20 stores therein the upper limit of multiplicity capable of performing multiple access to the LUN for each LUN of the disk group 21. When the copy session is to be executed, the disk array device 20 acquires the upper limit stored in association with the LUN where the data is stored and also acquires current multiplicity of the access to the LUN. Thereafter, when it is determined that the multiplicity for the LUN does not exceed the upper limit even if the copy session is executed, the disk array device 20 executes the copy session.

The disk array device 20 stores therein the upper limit of multiplicity capable of performing multiple access to the LUN for each LUN of the copy destination device. When the copy session is to be executed, the disk array device 20 acquires the upper limit stored in association with a transfer destination LUN of the data and also acquires current multiplicity of the access to the transfer destination LUN. Thereafter, when it is determined that the multiplicity for the transfer destination LUN does not exceed the upper limit even if the copy session is executed, the disk array device 20 executes the copy session.

As a result, the disk array device 20 can determine loads of the copy-source LUN and copy-destination LUN in addition to the load of each of remote lines, the load of each of copy-source RAID groups, and the load of each of copy-destination RAID groups. Therefore, it is possible to prevent the increase in the load of the remote line because heavy load of the LUN does not allow its end although the copying is executed. This results in efficient use of the remote lines as compared with the first and the second embodiments.

### [d] Fourth Embodiment

When abnormality occurs in the remote line, the disk array device disclosed in a fourth embodiment associates a REC path with a normal remote line, so that switching of the REC path can be automatically implemented. In the fourth embodiment, therefore, path failover for automatically switching the REC path to be associated with the remote line where abnormality is detected will be explained.

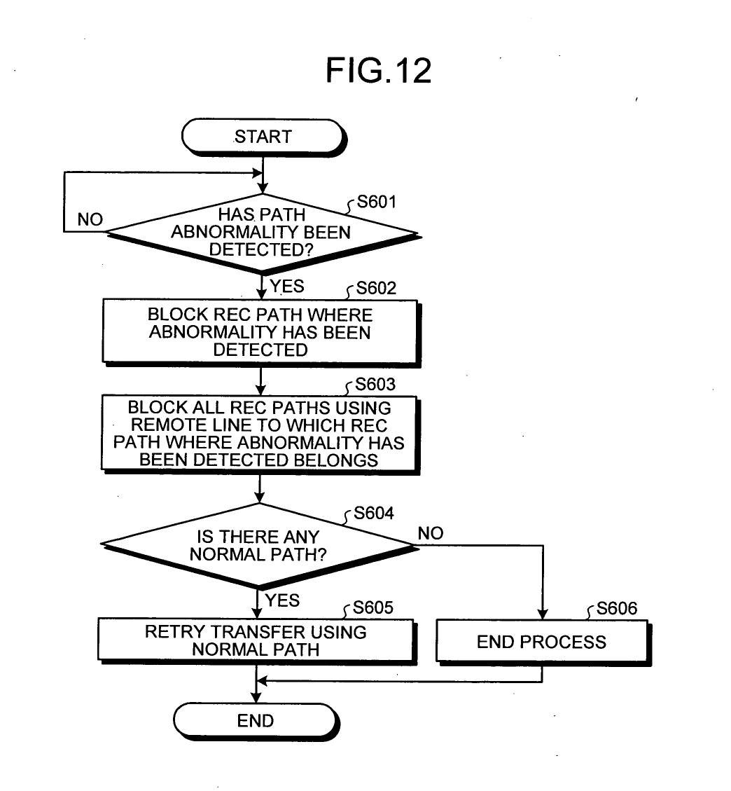

FIG. 12 is a flowchart representing a flow of a path failover process upon data transfer. As represented in FIG. 12, when detecting abnormality in the REC path upon data transfer (Yes at Step S601), the transfer executing unit 37 of the disk array device blocks the REC path where abnormality is detected (Step S602).

Then, the transfer executing unit 37 also blocks all the other REC paths that use the remote line to which the REC path where the abnormality is detected belongs (Step S603). Thereafter, the transfer executing unit 37 determines whether any other normal paths are present (Step S604). When it is determined that any other normal paths are present (Yes at Step S604), the transfer executing unit 37 retries the data transfer using the normal path (Step S605). Meanwhile, when it is determined that no other normal paths are present (No at Step S604), the transfer executing unit 37 ends the data transfer process (Step S606).

For example, it is assumed that the transfer executing unit 37 detects abnormality in a path when executing copying to the copy destination device B using the REC path “0x00” of the remote line “ID=0”. That is, the transfer executing unit 37 detects abnormality of the remote line “ID=0”. In this case, the transfer executing unit 37 changes the status of the REC path “0x00” stored in the remote line table 26 in association with the remote line “ID=0”, to “Abnormal”. In addition, the transfer executing unit 37 also changes the statuses of the REC paths “0x02, 0x04, 0x06” in association with the remote line “ID=0”, to “Abnormal”.

Thereafter, the transfer executing unit 37 refers to the remote line table 26 to determine where there is any normal REC path by setting the copy destination device B as the transfer destination device. For example, the transfer executing unit 37 specifies “0x00”, “0x02”, “0x04”, and “0x06” as REC paths related to the remote line “ID=0” corresponding to the copy destination device B, from the remote line table 26. The transfer executing unit 37 then determines whether there is any normal path depending on whether the REC paths “0x00”, “0x02”, “0x04”, and “0x06” are “Normal” or “Abnormal”. When any other normal path is present based on the copy destination device B as the transfer destination device, the transfer executing unit 37 uses the other normal path to execute the data transfer.

As explained above, according to the fourth embodiment, The disk array device stores therein REC paths associated with a remote line. Therefore, during operation of the failover when the abnormality is detected in a REC path caused by failure of the remote line, the disk array device can select smoothly a REC path connected to another remote line different from the remote line where failure occurs.

As a result, the disk array device immediately blocks the REC path connected to the abnormal remote line during the operation of the failover when the abnormality is detected in the REC path caused by failure of the remote line, so that smooth failover can be executed.

### [e] Fifth Embodiment

The embodiments of the present invention have been explained so far, however, the present invention may be implemented in any different embodiments other than the embodiments. Different embodiments will therefore be explained below.

Combination of Multiplicity Determinations

The disk array device disclosed in the present embodiment is capable of arbitrarily combining determinations of multiplicity explained in the first to the third embodiments. For example, the disk array device can determine only “Multiplicity of remote line” and thereby control stop and execution of copying. The disk array device can also determine “Multiplicity of remote line” and “Multiplicity of copy-source LUN” or determine “Multiplicity of remote line” and “Multiplicity of copy-destination LUN”, and thereby control copying.

In addition, the disk array device can determine “Multiplicity of remote line” and “Multiplicity of copy source and copy-destination LUNs”, and thereby control copying. The disk array device can also determine “Multiplicity of remote line” and “Multiplicity of copy-source and copy-destination RAID groups”, and thereby control copying. Moreover, the disk array device can determine “Multiplicity of remote line” and “Multiplicity of copy-source RAID group” or determine “Multiplicity of remote line” and “Multiplicity of copy-destination RAID group”, and thereby control copying.

Allocation to REC Path

The disk array device disclosed in the present embodiment can allocate a copy session as a target to be transferred to an arbitrary REC path. For example, the disk array device can select a REC path whose load is lowest and an REC path through which data transfer is not executed at this time to execute the copy session. The disk array device may sequentially select REC paths stored in the remote line table. When there is “one” copy session being the target to be transferred and there are “four” available REC paths, the disk array device divides the copy executed in the copy session into four, and may execute the divided copies through respective REC paths.

I/O Stop Command

When data copy is to be executed, the disk array device disclosed in the present embodiment can issue a command to stop other I/O to a copy-source LUN or to a copy-destination LUN and execute the data copy. As a result, the disk array device can prevent the number of operations from becoming larger than the operable number after the data copy is executed despite such determination that the number of operations is the operable number or less before execution of the data copy. That is, the disk array device can prevent the load of the copy-destination LUN or of the copy-source LUN from becoming large, after the data copy is executed, due to any cause other than copying.

Data Transfer

The first to the third embodiments have explained the examples of executing data copy, however, the present invention is not limited thereto. For example, the present invention can be applied to various cases of data transfer, which is not limited to the data copy, such as a case where data into which certain data and certain data are merged is to be transferred.

System

Of the respective processes explained in the embodiments, all or part of the processes explained as automatically performed one may be performed manually, or all or part of the processes explained as manually performed one such as generation of the REC path may be performed automatically using a known method. In addition, the information including the processing procedures, the control procedures, specific names, and various kinds of data and parameters represented in FIG. 3 through FIG. 5 and FIG. 10 can be optionally changed, unless otherwise specified.

The respective constituents of the illustrated devices are functionally conceptual, and the physically same configuration is not always necessary. In other words, the specific mode of distribution and integration of the devices is not limited to the illustrated ones. For example, all or part thereof may be functionally or physically distributed or integrated in an optional unit, such as integration of the copy-source determining unit 35 and the copy-destination determining unit 36, according to the various kinds of load and the status of use. Furthermore, all or part of the processing functions performed in the respective devices can be implemented by a central processing unit (CPU) and a program analyzed and executed by the CPU.

Program

The disk array control method explained in the embodiments can be implemented by executing a prepared program by a computer such as a personal computer or a work station. The program can be distributed through a network such as the Internet. The program may also be implemented by being recorded on a computer-readable recording medium such as a hard disk, a flexible disk (FD), CD-ROM, MO, and DVD, and being read from the recording medium by the computer.

According to one of modes of the disk array device and the control method for the disk array device disclosed in the present application, there is such an effect that data transfer can be executed with multiplicity suitable for each of lines.

All examples and conditional language-recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A disk array device comprising:
a storage unit that stores therein data;
a transfer-multiplicity storage unit that stores therein an upper limit of multiplicity capable of data transfer in parallel using a line for each line which is connected with a transfer destination device being a transfer destination of data stored in the storage unit;
a multiplicity determining unit that determines, when data transfer is to be executed, whether execution of the data transfer does not cause multiplicity to exceed the upper limit, based on the upper limit stored in the transfer-multiplicity storage unit in association with a line connected with a transfer destination device of the data transfer and also based on current multiplicity of the data currently transferred using the line; and
an execution control unit that executes the data transfer when it is determined by the multiplicity determining unit that the multiplicity does not exceed the upper limit.

2. The disk array device according to claim 1, further comprising:
a RAID-multiplicity storage unit that stores therein an upper limit of multiplicity capable of performing multiple access to a RAID group for each RAID group formed by the storage unit; and
a RAID determining unit that determines, when the data transfer is to be executed, whether execution of the data transfer does not cause multiplicity for the RAID group to exceed the upper limit, based on the upper limit stored in the RAID-multiplicity storage unit in association with a RAID group being a transfer source of the data and also based on current multiplicity of access to the RAID group, wherein
the execution control unit executes the data transfer when it is determined by the multiplicity determining unit that the multiplicity does not exceed the upper limit and when it is determined by the RAID determining unit that the multiplicity does not exceed the upper limit.

3. The disk array device according to claim 1, further comprising:
a RAID-multiplicity storage unit that stores therein an upper limit of multiplicity capable of performing multiple access to a RAID group, for each RAID group formed by the transfer destination device; and
a RAID determining unit that determines, when the data transfer is to be executed, whether execution of the data transfer does not cause multiplicity for the RAID group to exceed the upper limit, based on the upper limit stored in the RAID-multiplicity storage unit in association with a RAID group being a transfer source of the data and also based on current multiplicity of access to the RAID group, wherein
the execution control unit executes the data transfer when it is determined by the RAID determining unit that the multiplicity does not exceed the upper limit.

4. The disk array device according to claim 1, further comprising:
a volume-multiplicity storage unit that stores therein an upper limit of multiplicity capable of performing multiple access to a logical volume, for each logical volume of the storage unit; and
a volume determining unit that determines, when the data transfer is to be executed, whether execution of the data transfer does not cause multiplicity for the logical volume to exceed the upper limit, based on the upper limit stored in the volume-multiplicity storage unit in association with the logical volume where the data is stored and also based on current multiplicity of access to the logical volume, wherein
the execution control unit executes the data transfer when it is determined by the volume determining unit that the multiplicity does not exceed the upper limit.

5. The disk array device according to claim 1, further comprising:
a volume-multiplicity storage unit that stores therein an upper limit of multiplicity capable of performing multiple access to a logical volume, for each logical volume of the transfer destination device; and
a volume determining unit that determines, when the data transfer is to be executed, whether execution of the data transfer does not cause multiplicity for the logical volume to exceed the upper limit, based on the upper limit stored in the volume-multiplicity storage unit in association with the logical volume where the data is stored and also based on current multiplicity of access to the logical volume, wherein
the execution control unit executes the data transfer when it is determined by the volume determining unit that the multiplicity does not exceed the upper limit.

6. The disk array device according to claim 1, wherein
the multiplicity storage unit further stores therein at least one of logical paths provided between its own device and the transfer destination device internally determined by the own device in association with the multiplicity, for each of the lines, and
the execution control unit executes the data transfer through a logical path selected according to a predetermined condition, of the logical paths stored in multiplicity storage unit associated with the line that is connected with the transfer destination device of the data transfer.

7. The disk array device according to claim 6, further comprising a switch control unit that specifies, when a failure occurs in the line, a logical path associated with the line where the failure occurs from the multiplicity storage unit and newly associates the specified logical path with a normal line.

8. A control method for a disk array device, the control method comprising:
determining whether execution of data transfer does not cause multiplicity to exceed an upper limit, when data transfer is to be executed, based on the upper limit stored in a multiplicity storage unit that stores therein the upper limit of multiplicity capable of multiple data transfer using a line and also based on current multiplicity of data currently transferred using the line, for each line that is connected with a transfer destination device being a data transfer destination stored in a storage unit that stores therein the data in association with the line connected with the transfer destination device of the data transfer; and
executing the data transfer when it is determined at the determining that the multiplicity does not exceed the upper limit.
